(19) United States
(12) Patent Application Publication
(10) Pub. No.: US 2006/0001497 A1
(43) Pub. Date: Jan. 5, 2006

(54) Magnetic actuator trip and close circuit and related methods

(76) Inventor: Timothy M. Minteer, Pullman, WA (US)

Correspondence Address: Cook, Alex, McFarron, Manzo, Cummings & Mehler, Suite 2850, 200 West Adams, Chicago, IL, 60606, US

(21) Appl. No.: 10/883,149

(22) Filed: Jul. 1, 2004

(51) Int. Cl. H01H 75/00

(52) U.S. Cl. 331/139

(57) ABSTRACT

A circuit for a recloser controls the flow of current through an actuator coil to selectively open or close the electrical contacts of the recloser. The circuit utilizes pairs of transistors and pairs of diodes to apply the charge on a capacitor to open or close the contacts and to recharge the capacitor when the contacts open or close. The potential on the capacitor opposes current flow through the actuator coil for rapid decay of the actuator coil current, which also enables a rapid opening of the contacts after closure into a high current fault or the like. The capacitor also protects the transistors from voltage transients. Related methods are also presented.

### FIELD OF THE INVENTION

The present invention relates generally to electrical distribution systems. More particularly, the invention relates to apparatus and methods for tripping or closing of reclosers in electrical distribution systems.

### BACKGROUND OF THE INVENTION

Reclosers are sometimes referred to as auto-reclosers, auto-reclosing circuit breakers, reclosing relays, or the like. Reclosers have electrical contacts that close or open power lines in high voltage electrical distribution systems to provide electrical power to the power lines in the system. If an over-current or fault condition occurs, the recloser may open its electrical contacts at a known time delay after the occurrence of the over-current or fault condition. Actuation circuitry will sense any open condition of the recloser and one or more attempts will be made to reclose the electrical contacts of the recloser. However, if the over-current or fault condition persists, the recloser will typically go to a lock-out condition after failing to successfully reclose after about three attempts.

Reclosers typically have an actuator coil and an armature to move the electrical contacts to the closed position or to trip the electrical contacts from a previously closed position. Thus, current flowing through the actuator coil in one direction will cause the associated armature to close the electrical contacts, and current flowing through the actuator coil in the opposite direction will cause the armature to open the electrical contacts.

The prior art includes various types of circuits for applying sufficient current through the actuator coil of the recloser, as well as controlling the direction of current through the actuator coil, to selectively open or close the electrical contacts of the relay. In one such example, a capacitor of a larger value, such as greater than 1000 microfarads is charged through a diode from a variable DC voltage source of about 160 volts. At an appropriate time, a transistor is turned on to pass current from the capacitor to the actuator coil of the recloser and back to the capacitor. A resistor and second a diode, in series with the actuator coil, provide a freewheeling current path for the actuator coil when the transistor is turned off. Current through the resistor provides a voltage that opposes the voltage across the actuator coil, which causes the current flowing through the actuator coil to decrease. The speed at which the current decreases to zero is determined by the circuit design.

In order for current to be directed in either direction through the actuator coil, a double-pole, double-throw (DPDT) relay may be employed in a manner that directs current through the actuator coil in a first direction when the DPDT relay has its contacts in a first position and that directs current through the actuator coil in the opposite direction when the DPDT relay has its contacts in the opposite position. Such operation of energization of the actuator coil in either direction will allow control of the closing and of the tripping of the recloser.

Such a circuit design for controlling a magnetic actuator works adequately in most situations. However, if the recloser is closed into a high current fault condition, it is important to be able to very rapidly trip the recloser following the close. In this situation, the contacts of the DPDT relay may be damaged if the DPDT relay is switched to the opposite position to open or trip the recloser because the current flowing through the actuator coil may not yet have decayed to zero from the prior close operation. Thus, it is important for the current through the actuator coil to decrease to zero as rapidly as possible, especially after closing the recloser. A larger value of resistance will cause the actuator coil current to decrease more rapidly, but a higher value of resistance also places higher voltage stresses on the transistor.

Furthermore, to open or trip the recloser, other delays are encountered. The capacitor must adequately recharge from the DC voltage source to supply sufficient energy to the actuator coil to open or trip the recloser and the DPDT relay must also change its position to route current through the actuator coil in the opposite direction. These delays may be in addition to the delay of the current in the actuator coil decaying to zero from the prior close operation. After these conditions have been satisfied, the transistor may be turned on to supply current from the capacitor to the actuator coil in the opposite direction to open or trip the recloser. At the appropriate time when the transistor is turned off, current continuing to flow through the actuator coil begins to circulate through the resistor and second diode. As during the close operation, current flowing through the resistor creates a voltage that opposes the voltage across the actuator coil. This causes the current flowing through the actuator coil to decrease and eventually stop.

Thus, there has been a long-felt need for an effective means of controlling the current through an actuator coil of a recloser in a manner that permits rapid trip or opening of the recloser if the recloser is closed into a high current fault condition.

Accordingly, it is a general object of the present invention to provide more effective circuitry for closing and for tripping a recloser.

Another object of the present invention is to provide circuitry for closing and for tripping a recloser that places less voltage stress on the transistors in the circuit.

Yet another object of the present invention is to more rapidly decay the current through the actuator coil after a closing operation of the recloser.

A further object of the present invention is to provide circuitry for controlling the magnetic actuator of a recloser in a manner that permits rapid opening of the recloser after closing of the recloser into a high current fault condition.

### BRIEF SUMMARY OF THE INVENTION

This invention is directed to circuitry for controlling the flow of current through an actuator coil of a recloser to selectively open or close electrical contacts of the recloser depending upon the direction of current flow through the actuator coil. The circuitry includes a source of DC voltage, a capacitor that is charged from the source of DC voltage, a first pair of transistors connected in series with the actuator coil to apply the charge from the capacitor to the actuator coil with a polarity that will energize the actuator coil to close the electrical contacts of the recloser when the first pair of transistors is rendered conductive, a first pair of diodes, one of each of the first pair of diodes in parallel with one of a second pair of transistors and poled to conduct current from the actuator coil in a direction that will recharge the capacitor when the first pair of transistors are turned off upon closure of the electrical contacts of the recloser, a second pair of transistors connected in series with the actuator coil to apply the charge from the capacitor to the actuator coil with an opposite polarity that will energize the actuator coil to open the electrical contacts of the recloser when the second pair of transistors are rendered conductive and a second pair of diodes, one of each of the second pair of diodes in parallel with one of the first pair of transistors and poled to conduct current from the actuator coil in a direction that will recharge the capacitor when the second pair of transistors are turned off upon opening of the electrical contacts of the recloser.

The voltage potential associated with the charge across the capacitor acts to oppose current flow through the actuator coil upon turn off of the first pair of transistors, as well as upon turn off of the second pair of transistors. The current flowing through the actuator coil thus rapidly decays toward zero after closing or opening of the electrical contacts. The capacitor also protects the transistors from voltage transients that may occur in the circuit.

The second pair of transistors may be biased to be conductive to trip the recloser as soon as the first pair of transistors is turned off, or while the current flow through the actuator coil from a prior closure of the electrical contacts is still decaying toward zero. The second pair of transistors then applies the charge on the capacitor to the actuator coil as soon as the current through the actuator coil from the closing of the electrical contacts by the first pair of transistors decays to zero to open the electrical contacts.

The invention also includes reclosers that include or utilize the above circuitry.

The present invention further includes methods of controlling the flow of current through an actuator coil of a recloser to selectively open or close electrical contacts of the recloser depending upon the direction of current flow through the actuator coil. The methods include the steps of charging a capacitor from a source of DC voltage, rendering a first pair of transistors conductive to apply the charge from the capacitor to the actuator coil with a polarity that will energize the actuator coil to close the electrical contacts of the recloser, providing a first pair of diodes in generally parallel circuit arrangement with a second pair of transistors, poling the first pair of diodes to conduct current in a direction that will recharge the capacitor with the current from the actuator coil when the first pair of transistors is rendered nonconductive, rendering a second pair of transistors conductive to apply the charge from the capacitor to the actuator coil with an opposite polarity that will energize the actuator coil to open the electrical contacts of the recloser, providing a second pair of diodes in generally parallel circuit arrangement with the first pair of transistors and poling the second pair of diodes to conduct current in a direction that will recharge the capacitor with current from the actuator coil when the second pair of transistors is rendered nonconductive.

The methods may further include the steps of opposing the flow of current through the actuator coil upon turn off of the first pair of transistors with a voltage potential associated with the charge on the capacitor and/or opposing the flow of current through the actuator coil upon turn off of the second pair of transistors with a voltage potential associated with the charge on the capacitor. The step of biasing the second pair of transistors to be conductive to open the recloser before the current through the actuator coil decays to zero from a prior closing of the electrical contacts of the recloser may also be included.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the figures in which like reference numerals identify like elements, and in which:

FIG. 1 is an electrical schematic diagram of a circuit useful for controlling a magnetic actuator of a recloser in accordance with the present invention.

### DESCRIPTION OF THE PREFERRED EMBODIMENT

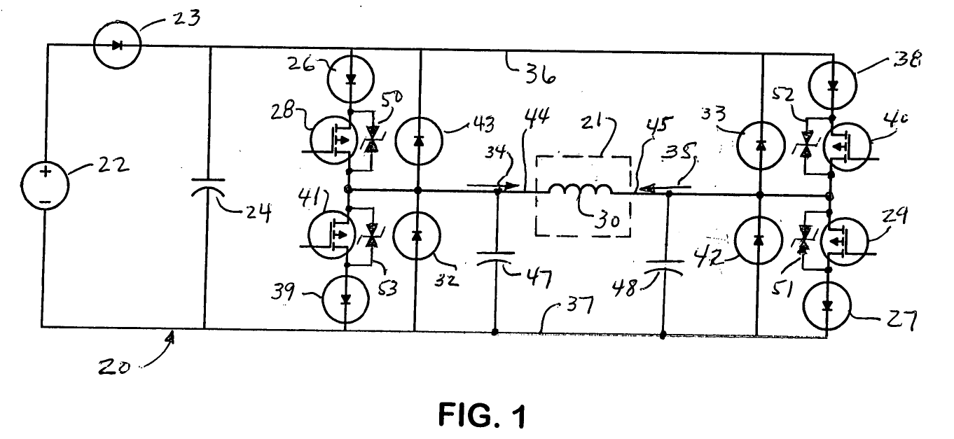

An electronic circuit, generally designated 20, for controlling the magnetic actuator of a recloser 21 in accordance with the present invention is shown in FIG. 1. The magnetic actuator includes an actuator coil 30 which is selectively energized by circuit 20 to open or close electrical contacts (not shown) in the recloser 21 in a manner known in the art, depending upon the direction of current through the actuator coil. Typically, recloser 21, including actuator coil 30, is located in a box at an elevated position on a utility pole or transmission tower, such as near or adjacent to the transmission lines of an electrical distribution system. On the other hand, circuit 20 is typically located close to ground level, with a pair of lines 44 and 45 providing electrical connection from circuit 20 to actuator coil 30. The length of lines 44-45 between actuator coil 30 and circuit 20 is thus exposed to the air and to ambient conditions associated with the electrical distribution system. As such, lines 44-45 can induce voltage transients to that portion of circuit 20 connected to lines 44-45.

Circuit 20 may include a source of DC voltage 22, which may vary between 0 and 200 volts. For example, DC voltage at voltage source 22 may be supplied by half-wave or full-wave rectification of AC voltage. Alternatively, the source of DC voltage may be provided to circuit 20 by the recloser. A diode 23 in series with the DC voltage source is conductive when the potential at the DC voltage source is greater than the potential across a capacitor 24 to charge the capacitor toward the peak value of the DC voltage source. For example, capacitor 24 may charge to about 160 volts, or greater. The capacitive value of capacitor 24 is selected to supply the appropriate amount of energy to actuator coil 30. For example, capacitor 24 may have a capacitance of 1000 or more microfarads.

In the example of FIG. 1, it is assumed that in order to close the electrical contacts of the recloser 21, current must pass through actuator coil 30 from left to right in the direction indicated by arrow 34. Thus, when it is desired to close the electrical contacts of the recloser 21, an appropriate bias is applied to the gate terminals of transistors 28 and 29 to render them conductive. Capacitor 24 then supplies current through diode 26, transistor 28, through actuator coil 30 (in the direction indicated by arrow 34), through transistor 29, through diode 27 and back to capacitor 24. When the electrical contacts of the recloser 21 close, transistors 28 and 29 are turned off by applying an appropriate potential to their gate terminals.

When transistors 28 and 29 turn off, current flowing through actuator coil 30 in the direction of arrow 34 continues to flow through the freewheeling path comprising diodes 32 and 33. Note that current flowing in the path defined by diodes 32 and 33 acts to recharge capacitor 24. This also develops an increasing voltage across capacitor 24 that will oppose current flowing through actuator coil 30, which will cause the current to rapidly decrease toward zero.

In accordance with one aspect of the present invention, a trip command can quickly follow a close command since the circuit in FIG. 1 forces the current circulating through diodes 32 and 33 to zero faster than the prior art circuit discussed above in the Background of the Invention. This is due to two factors. First, the voltage developed across the actuator coil 30 is larger than in the prior art circuit. Second, the voltage on the capacitor increases as it is recharged and as the current through the actuator coil decreases. Since the prior art circuit relied upon the voltage established across a resistor to oppose the current flow through the actuator coil, the opposing voltage across the resistor decreases as the current through the coil decreases. Thus, the circuit of the present invention shown in FIG. 1 forces the current flowing through the actuator coil to zero in about half the time as the prior art technique. A trip or open command can thus occur much sooner after the completion of a close command and without presenting any damage to the associated equipment, particularly when the recloser closes into a high current fault or the like.

The trip or open operation for the circuit illustrated in FIG. 1 follows a similar sequence of steps as the close operation described above. For the trip operation of the recloser 21, it is assumed that current must pass through the actuator coil 30 from right to left in the direction of arrow 35. Thus, when it is desired to trip the electrical contacts of the recloser 21, such as due to an overload or high fault current condition, an appropriate bias is applied to the gate terminals of transistors 40 and 41 to render them conductive. Capacitor 24 then supplies current through diode 38, through transistor 40, through actuator coil 30 (in the direction indicated by arrow 35), through transistor 41, through diode 39 and back to capacitor 24. When the electrical contacts of the recloser 21 open, transistors 40 and 41 are turned off by applying an appropriate potential to their gate terminals.

When transistors 40 and 41 turn off, current flowing through actuator coil 30 in the direction of arrow 35 continues to flow through another freewheeling path comprising diodes 42 and 43. Note that current flowing in the path defined by diodes 42 and 43 also acts to recharge capacitor 24. This also develops an increasing voltage across capacitor 24 that will oppose current flowing through actuator coil 30, which will cause the current through the actuator coil to rapidly decrease toward zero.

Diodes 26-27 and 38-39, which are in series with transistors 28-29 and 40-41, respectively, operate to block flyback or transient currents from flowing through the respective transistors. For example, when transistor 41 stops conducting, the voltage reverses on actuator coil 30 which provides a reverse potential across transistor 28 and diode 26 when line 44 is positive with respect to line 36. However, diode 26 will then be reverse-biased and will prevent reverse current from flowing through transistor 28. Under these circumstances, diode 43 will become conductive and will typically limit the reverse bias to less than one volt. Diodes 27 and 38-39 provide similar protection for their respective transistors.

In accordance with another aspect of the present invention, a trip command can be issued before the close operation is complete. For example, if transistors 40 and 41 are biased on and transistors 28 and 29 are biased off simultaneously, circuit 20 would operate as previously described until the closing current (in the direction of arrow 34) through actuator coil 30 decreases to zero. At that time, trip current begins flowing from capacitor 24 through actuator coil 30 in the direction of arrow 35, causing the recloser 21 to reopen its electrical contacts. Circuit 20 thus allows the fastest possible trip time following a close into a high current fault.

In accordance with yet another aspect of the present invention, capacitor 24 protects transistors 28-29 and 40-41 and diodes 32-33 and 42-43 during transient events. For example, such transient events may be caused by lightning induced voltage, power system faults and the like. During any such events, any high voltages that may occur on lines 44 and 45 are clamped by capacitor 24, thus protecting the semiconductors from potentially destructive over voltages. Any voltage surges tend to charge capacitor 24 to a higher voltage, or to discharge capacitor 24 to a lower voltage. Since capacitor 24 is of a relatively high capacitance, capacitor 24 will effectively filter any voltage transients that may occur, such as on lines 44-45 and/or in actuator coil 30. Transistors 28-29 and 40-41 will therefore not be subjected to the peak voltages of any such transients.

Moreover, if transistors 28-29 and 40-41 are of the MOSFET type, each of such transistors is usually provided with an internal protective metal-oxide varistor (MOV) that is electrically in parallel with the transistor. For example, in FIG. 1, MOV 50 is in parallel with transistor 28, MOV 51 is in parallel with transistor 29, MOV 52 is in parallel with transistor 40 and MOV 53 is in parallel with transistor 41. MOVs 50-53 provide bi-directional transient suppression to protect transistors 28-29 and 40-41 from over-voltage transients that may occur in either direction. Additional transient suppression is provided by capacitors 47 and 48, which are connected between lines 44 and 37 and between lines 45 and 37, respectively.

If a positive-going transient occurs on line 44 (to the left of actuator coil 30 in FIG. 1), circuit 20 provides three distinct paths with respect to line 37. A first path is through capacitor 47, a second path is through MOV 53 and diode 39, and a third path is through diode 43 and capacitor 24. If a negative-going transient occurs on line 44, circuit 20 also provides three distinct paths with respect to line 37. A first path is through capacitor 47, a second path is through MOV 50, diode 26 and capacitor 24, and a third path is through diode 32. A similar analysis may be applied to positive and negative-going transients that may occur to the right of actuator coil 30 on line 45.

It will be appreciated that transistors 28-29 and 40-41 can be any type of semiconductor switching element, such as the MOSFET type of transistors indicated by the symbols in FIG. 1, a bipolar type of transistor, or any other suitable semiconductive switching device.

In view of the above presentation of the circuit 20, it will be appreciated that the present invention also includes methods of controlling the flow of current through an actuator coil 30 of a recloser 21 to selectively open or close electrical contacts of the recloser depending upon the direction of current flow through the actuator coil 30. The methods include the steps of charging a capacitor 24 from a source of DC voltage 22, rendering a first pair of transistors 28 and 29 conductive to apply the charge from the capacitor 24 to the actuator coil 30 with a polarity that will energize the actuator coil to close the electrical contacts of the recloser 21, providing a first pair of diodes 32 and 33 in generally parallel circuit arrangement with a second pair of transistors 40 and 41, poling the first pair of diodes to conduct current in a direction that will recharge the capacitor 24 with the current from the actuator coil 30 when the first pair of transistors 28 and 29 is rendered nonconductive, rendering a second pair of transistors 40 and 41 conductive to apply the charge from the capacitor 24 to the actuator coil 30 with an opposite polarity that will energize the actuator coil to open the electrical contacts of the recloser 21, providing a second pair of diodes 42 and 43 in generally parallel circuit arrangement with the first pair of transistors 28 and 29 and poling the second pair of diodes 42 and 43 to conduct current in a direction that will recharge capacitor 24 with current from the actuator coil 30 when the second pair of transistors 40 and 41 is rendered nonconductive.

The methods may further include the steps of opposing the flow of current through the actuator coil 30 upon turn off of the first pair of transistors 28 and 29 with a voltage potential associated with the charge on capacitor 24 and/or opposing the flow of current through the actuator coil 30 upon turn off of the second pair of transistors 40 and 41 with a voltage potential associated with the charge on the capacitor. The step of biasing the second pair of transistors 40 and 41 to be conductive to open the recloser before the current through the actuator coil decays to zero from a prior closing of the electrical contacts of the recloser may also be included.

While particular embodiments of the invention have been shown and described, it will be obvious to those skilled in the art that changes and modifications may be made therein without departing from the invention in its broader aspects.

1. A circuit for controlling the flow of current through an actuator coil of a recloser to selectively open or close electrical contacts of the recloser depending upon the direction of current flow through the actuator coil, said circuit comprising:
a source of DC voltage;
a capacitor that is charged from the DC source of voltage;
a first pair of transistors connected in series with said actuator coil to apply the charge from the capacitor to said actuator coil with a polarity that will energize the actuator coil to close the electrical contacts of the recloser when the first pair of transistors is rendered conductive;
a first pair of diodes, one of each of the first pair of diodes in parallel with one of a second pair of transistors and poled to conduct current from the actuator coil in a direction that will recharge the capacitor when the first pair of transistors is turned off upon closure of the electrical contacts of the recloser;
a second pair of transistors connected in series with said actuator coil to apply the charge from the capacitor to said actuator coil with an opposite polarity that will energize the actuator coil to open the electrical contacts of the recloser when the second pair of transistors is rendered conductive; and
a second pair of diodes, one of each of the second pair of diodes in parallel with one of said first pair of transistors and poled to conduct current from the actuator coil in a direction that will recharge the capacitor when the second pair of transistors is turned off upon opening of the electrical contacts of the recloser.

2. The circuit for controlling the flow of current through an actuator coil of a recloser as defined in claim 1 wherein a voltage potential associated with the charge across the capacitor acts to oppose current flow through the actuator coil upon turn off of the first pair of transistors and upon turn off of the second pair of transistors.

3. The circuit for controlling the flow of current through an actuator coil of a recloser as defined in claim 2 wherein current flowing through the actuator coil rapidly decays toward zero.

4. The circuit for controlling the flow of current through an actuator coil of a recloser as defined in claim 1 wherein the capacitor protects the first pair of transistors and the second pair of transistors from voltage transients that may occur in said circuit.

5. The circuit for controlling the flow of current through an actuator coil of a recloser as defined in claim 1 wherein the second pair of transistors may be biased to be conductive to trip the recloser as soon as the first pair of transistors is turned off.

6. The circuit for controlling the flow of current through an actuator coil of a recloser as defined in claim 5 wherein the second pair of transistors applies the charge on the capacitor to the actuator coil as soon as the current through the actuator coil from the closing of the electrical contacts by the first pair of transistors decays to zero.

7. The circuit for controlling the flow of current through an actuator coil of a recloser as defined in claim 1 further comprising a flyback diode in series with each of said first pair of transistors and each of said second pair of transistors to prevent reverse conduction in each of said first pair of transistors and each of said second pair of transistors during flyback condition of the actuator coil.

8. The circuit for controlling the flow of current through an actuator coil of a recloser as defined in claim 1 further comprising a transient suppression device in parallel with each of said first pair of transistors and in parallel with each of said second pair of transistors to assist in suppression of transients in the circuit.

9. The circuit for controlling the flow of current through an actuator coil of a recloser as defined in claim 1 further comprising a first capacitor connected at a first end of said actuator coil and a second capacitor connected at a second end of said actuator coil to assist in suppression of transients in the circuit.

10. A circuit for controlling the flow of current through an actuator coil of a recloser to selectively open or close electrical contacts of the recloser depending upon the direction of current flow through the actuator coil, said recloser providing a source of DC voltage, said circuit comprising:
a capacitor that is charged from the DC source of voltage;
a first pair of transistors connected in series with said actuator coil to apply the charge from the capacitor to said actuator coil with a polarity that will energize the actuator coil to close the electrical contacts of the recloser when the first pair of transistors is rendered conductive;
a first pair of diodes, one of each of the first pair of diodes in parallel with one of a second pair of transistors and poled to conduct current from the actuator coil in a direction that will recharge the capacitor when the first pair of transistors is turned off upon closure of the electrical contacts of the recloser;
a second pair of transistors connected in series with said actuator coil to apply the charge from the capacitor to said actuator coil with an opposite polarity that will energize the actuator coil to open the electrical contacts of the recloser when the second pair of transistors is rendered conductive; and
a second pair of diodes, one of each of the second pair of diodes in parallel with one of said first pair of transistors and poled to conduct current from the actuator coil in a direction that will recharge the capacitor when the second pair of transistors is turned off upon opening of the electrical contacts of the recloser.

11. The circuit for controlling the flow of current through an actuator coil of a recloser as defined in claim 10 wherein a voltage potential associated with the charge across the capacitor acts to oppose current flow through the actuator coil upon turn off of the first pair of transistors and upon turn off of the second pair of transistors.

12. The circuit for controlling the flow of current through an actuator coil of a recloser as defined in claim 11 wherein current flowing through the actuator coil rapidly decays toward zero.

13. The circuit for controlling the flow of current through an actuator coil of a recloser as defined in claim 10 wherein the capacitor protects the first pair of transistors and the second pair of transistors from voltage transients that may occur in said circuit.

14. The circuit for controlling the flow of current through an actuator coil of a recloser as defined in claim 10 wherein the second pair of transistors may be biased to be conductive to trip the recloser as soon as the first pair of transistors is turned off.

15. The circuit for controlling the flow of current through an actuator coil of a recloser as defined in claim 14 wherein the second pair of transistors applies the charge on the capacitor to the actuator coil as soon as the current through the actuator coil from the closing of the electrical contacts by the first pair of transistors decays to zero.

16. The circuit for controlling the flow of current through an actuator coil of a recloser as defined in claim 10 further comprising a flyback diode in series with each of said first pair of transistors and each of said second pair of transistors to prevent reverse conduction in each of said first pair of transistors and each of said second pair of transistors during flyback condition of the actuator coil.

17. The circuit for controlling the flow of current through an actuator coil of a recloser as defined in claim 10 further comprising a transient suppression device in parallel with each of said first pair of transistors and in parallel with each of said second pair of transistors to assist in suppression of transients in the circuit.

18. The circuit for controlling the flow of current through an actuator coil of a recloser as defined in claim 10 further comprising a first capacitor connected at a first end of said actuator coil and a second capacitor connected at a second end of said actuator coil to assist in suppression of transients in the circuit.

19. A method of controlling the flow of current through an actuator coil of a recloser to selectively open or close electrical contacts of the recloser depending upon the direction of current flow through the actuator coil, said method comprising the steps of:
charging a capacitor from a source of DC voltage;
rendering a first pair of transistors conductive to apply the charge from the capacitor to said actuator coil with a polarity that will energize the actuator coil to close the electrical contacts of the recloser;
providing a first pair of diodes in generally parallel circuit arrangement with a second pair of transistors;
poling the first pair of diodes to conduct current in a direction that will recharge the capacitor with the current from the actuator coil when the first pair of transistors is rendered nonconductive;
rendering a second pair of transistors conductive to apply the charge from the capacitor to said actuator coil with an opposite polarity that will energize the actuator coil to open the electrical contacts of the recloser;
providing a second pair of diodes in generally parallel circuit arrangement with the first pair of transistors; and
poling the second pair of diodes to conduct current in a direction that will recharge the capacitor with current from the actuator coil when the second pair of transistors is rendered nonconductive.

20. The method of controlling the flow of current through an actuator coil of a recloser as defined in claim 19, said method comprising the additional step of:
opposing the flow of current through the actuator coil upon turn off of the first pair of transistors with a voltage potential associated with the charge on the capacitor.

21. The method of controlling the flow of current through an actuator coil of a recloser as defined in claim 19, said method comprising the additional step of:
opposing the flow of current through the actuator coil upon turn off of the second pair of transistors with a voltage potential associated with the charge on the capacitor.

22. The method of controlling the flow of current through an actuator coil of a recloser as defined in claim 19, said method comprising the additional step of:
biasing the second pair of transistors to be conductive to open the recloser before the current through the actuator coil decays to zero from a prior closing of the electrical contacts of the recloser.

23. The method of controlling the flow of current through an actuator coil of a recloser as defined in claim 19, said method comprising the additional step of:
providing protection against reverse current conduction in said first pair of transistors and in said second pair of transistors.

24. The method of controlling the flow of current through an actuator coil of a recloser as defined in claim 19, said method comprising the additional step of:
providing transient voltage surge protection for said first pair of transistors and for said second pair of transistors.

25. A recloser with circuitry for controlling the flow of current through an actuator coil of the recloser to selectively open or close electrical contacts of the recloser depending upon the direction of current flow through the actuator coil, said recloser providing a source of DC voltage, said recloser further comprising:
a capacitor that is charged from the DC source of voltage;
a first pair of transistors connected in series with said actuator coil to apply the charge from the capacitor to said actuator coil with a polarity that will energize the actuator coil to close the electrical contacts of the recloser when the first pair of transistors is rendered conductive;
a first pair of diodes, one of each of the first pair of diodes in parallel with one of a second pair of transistors and poled to conduct current from the actuator coil in a direction that will recharge the capacitor when the first pair of transistors is turned off upon closure of the electrical contacts of the recloser;
a second pair of transistors connected in series with said actuator coil to apply the charge from the capacitor to said actuator coil with an opposite polarity that will energize the actuator coil to open the electrical contacts of the recloser when the second pair of transistors is rendered conductive; and
a second pair of diodes, one of each of the second pair of diodes in parallel with one of said first pair of transistors and poled to conduct current from the actuator coil in a direction that will recharge the capacitor when the second pair of transistors is turned off upon opening of the electrical contacts of the recloser.

26. The recloser with circuitry for controlling the flow of current through an actuator coil of the recloser as defined in claim 25 wherein a voltage potential associated with the charge across the capacitor acts to oppose current flow through the actuator coil upon turn off of the first pair of transistors and upon turn off of the second pair of transistors.

27. The recloser with circuitry for controlling the flow of current through an actuator coil of the recloser as defined in claim 25 wherein current flowing through the actuator coil rapidly decays toward zero.

28. The recloser with circuitry for controlling the flow of current through an actuator coil of the recloser as defined in claim 25 wherein the capacitor protects the first pair of transistors and the second pair of transistors from voltage transients that may occur in said circuit.

29. The recloser with circuitry for controlling the flow of current through an actuator coil of a recloser as defined in claim 25 wherein the second pair of transistors may be biased to be conductive to trip the recloser as soon as the first pair of transistors is turned off.

30. The recloser with circuitry for controlling the flow of current through an actuator coil of the recloser as defined in claim 29 wherein the second pair of transistors applies the charge on the capacitor to the actuator coil as soon as the current through the actuator coil from the closing of the electrical contacts by the first pair of transistors decays to zero.

31. The recloser with circuitry for controlling the flow of current through an actuator coil of the recloser as defined in claim 25 further comprising a flyback diode in series with each of said first pair of transistors and each of said second pair of transistors to prevent reverse conduction in each of said first pair of transistors and each of said second pair of transistors during flyback condition of the actuator coil.

32. The recloser with circuitry for controlling the flow of current through an actuator coil of the recloser as defined in claim 25 further comprising a transient suppression device in parallel with each of said first pair of transistors and in parallel with each of said second pair of transistors to assist in suppression of transients in the circuit.

33. The recloser with circuitry for controlling the flow of current through an actuator coil of the recloser as defined in claim 25 further comprising a first capacitor connected at a first end of said actuator coil and a second capacitor connected at a second end of said actuator coil to assist in suppression of transients in the circuit.
